(19) United States
(12) Patent Application Publication
(10) Pub. No.: US 2010/0194761 A1
(43) Pub. Date: Aug. 5, 2010

(54) CONVERTING CHILDREN'S DRAWINGS INTO ANIMATED MOVIES

(76) Inventor: PHILLIP RHEE, PORTER RANCH, VA (US)

Correspondence Address: PHILLIP;RHEE, 12126, SHADOW RIDGE WY, PORTER RANCH, CA, 91326, US

(21) Appl. No.: 12/363,804

(22) Filed: Feb. 2, 2009

(51) Int. Cl. G06T 15/70

(52) U.S. Cl. 345/473

(57) ABSTRACT

The present invention comprises of a business method and music and text-derived speech animation software for producing simple, effective animations of digital media content that educate, entertain the children and views by the presentation of speaking digital characters. The invention makes the creation of digital talking characters both easy and effective to produce. The completed animation is then provided to the children who made the drawings and optionally posted on a website accessible through the Internet or used for the creation of online Greeting Cards and Story books.

### FIELD OF INVENTION

The present invention relates to field of computer animation. More particularly the invention relates to a business method and software technique for the creation of animated movies and specifically to the conversion of children's drawings into animated movies by using music and voice over.

### BACKGROUND OF THE INVENTION

Animation is a graphic representation of drawings to show movement within those drawings. A series of drawings are linked together and usually photographed by a camera. The drawings are slightly changed between individualized frames so when they are played back in rapid succession (24 frames per second) there appears to be seamless movement within the drawings. Early animations, which started appearing before 1910, consisted of simple drawings photographed one at a time. It was extremely labor intensive as there were literally hundreds of drawings per minute of film.

The development of celluloid around 1913 quickly made animation easier to manage. Instead of numerous drawings, the animator now could make a complex background and/or foreground and sandwich moving characters in between several other pieces of celluloid, which is transparent except for where drawings are painted on it. This made it unnecessary to repeatedly draw the background as it remained static and only the characters moved. It also created an illusion of depth, especially if foreground elements were placed in the frames.

With the advent of personal computers, it has now become possible to allow animations to enrich the everyday lives of people. Computer generated animations have wide applications and have improved as hardware has improved. As the personal computer industry has evolved into a multi-billion dollar economy, high quality graphics rendering systems have become less expensive. Graphics systems once costing many hundreds of thousands of dollars are now available at a fraction of that cost.

Animation is a powerful way to attract and sequence users' attention in an electronic presentation. It is possible to animate text, graphics, diagrams, charts, and other objects to focus an audience on important points, control the flow of information, and add interest to a presentation. Animation in a presentation occurs when objects or animation effects on these objects in a slide are scheduled by the user to appear in a prescribed sequence. When the user then inputs a command for one or more of the objects or effects to appear, they appear in a certain order. For example, a user can have a text bullet on a slide fly into the slide from the left, one word at a time, or hear the sound of applause when a picture is uncovered.

The relevant prior art methods, which deal with animation methods and software, are as follows:

U.S. Pat. No. 7,055,131 describes an improved software development tool that allows a developer to animate the execution of compiled source code as a diagram. The developer may choose to stepwise animate one line of source code at a time.

U.S. Pat. No. 7,075,531 claims a method of efficiently creating an animation image data files. Components of a device are modeled using a 3-D CAD system and filed. After file format conversion, the file is imported to application software for animation. The components are then assembled, a camera angle is selected, and the transparency of the components is specified. A video file is created and included in an HTML file which is a completed animation data file.

U.S. Pat. No. 7,197,710 describes a system and method for graphically showing the animation order of animated elements in a presentation program or other software. The invention consists of a User Interface (UI) widget which shows the order of the animation in the presentation. This UI employs an animation On Object User Interface (OOUI), or animation tag, that is preferably a rectangular control that encloses a number, and labels the order in which objects are animated.

U.S. Pat. No. 7,315,820 discloses a text-derived speech animation tool for producing simple, effective animations of digital media content that educate, entertain, and inform viewers by the presentation of speaking digital characters.

U.S. Pat. No. 6,593,936 claims a method and system for description of synthetic audiovisual content that makes it easier for humans, software components or devices to identify, manage, categorize, search, browse and retrieve such content.

U.S. Pat. No. 7,086,032 describes a system and method for representing object animation, such as the movement of mouse pointers, within presentations based on software application programs or other information displayed by a computer system is disclosed herein.

U.S. Pat. No. 6,738,065 discloses a system and method to provide customizable animation. A motion capture database houses a library of human motion that is accessible via a client-server connection. Users are allowed to select motion sequences and alter these motions in real time over a networked connection to create new and original works of art. In one embodiment, blender software is used to interpolate and extrapolate from existing library data to create the new and original motion sequences that are developed to comply with bio-mechanical laws, physics and human anatomy.

U.S. Pat. No. 6,167,562 reveals an apparatus for creating an animation program for use with game software and presentations with high efficiency, without requirements for a high degree of programming techniques. The animation program creating apparatus has a moving image drawing device with a program storing circuit for storing animation programs, a character image drawing circuit for drawing character images, and a background image drawing circuit for drawing background images.

U.S. Pat. No. 6,433,784 claims a method for preparing animated characters for use on the Internet or in other environments. Once generated, the resulting choreography can be embedded into a hypertext markup language (HTML) web page with an appropriate audio player plug-in to deliver any number of animated dialogues with minimal wait time and minimal developer effort, or can be similarly embedded or used with other software.

U.S. Pat. No. 5,946,002 describes a method for implementing animations which reduces the complexity associated with animations, creates a uniform mechanism for implementing an animation, and allows the repositioning and resizing of an animation within a parent window without software recompilation. Another embodiment includes an animation object which modularizes the methods required to implement an animation.

U.S. Pat. No. 6,549,205 discloses a system for producing an animation on a computer by use of keyframes, shapes are drawn on the basis of the positions of vertices designated by a user without direct manipulation of control points for Bezier curve so that there is little problem even in the case where a line drawing of each handwritten keyframe is broken discontinuously.

U.S. Pat. No. 6,054,999 claims a method for producing computer processed animation that includes a work station composed of a computer and peripheral equipment which produces a graphic movement sequence for a cartoon figure, by compiling a recording of measured data from strategic parts of an actor, and storing in a memory information concerning the figure to be animated.

U.S. Pat. No. 6,924,803 discloses a method and system for creating an object or character in a drawing window and simultaneously displaying the object or character in animated form wherein the animated form is available for instant playback or feedback to the user is described.

However most of the above prior art relates only to industrial animation methods and techniques used for various professional purposes.

Further some of the above prior art describes software such as Flash for use in many different methods such as manipulation, of images, text, objects and figures but not used directly with children's drawings to create a whole new medium of an animated movies based on a child's drawing.

Further some of the above prior art describes providing animation services to casual users, having little or no experience in creating animations or using animation software packages.

Again normally drawings are interesting when drawn but incapable of maintaining the interest level of most children. Typically, children become tired or bored with the limited visual and audible feedback.

The present invention differs from the existent prior art in that it provides a method and software to convert children's drawings into animated content. The present invention further aims at providing challenging educational drawings for children with some added excitement being provided by the LED displays and/or the audible sounds.

Further since animation is of great interest especially to children, the present invention can serve as a useful and exciting entertaining tool in developing creativity and confidence among the children.

It will be apparent to those skilled in the art that the objects of this invention have been achieved by providing a method and software specifically focused on turning children's drawing into animated movie with the music and movements. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This present invention may be summarized, at least in part, with reference to its objects.

The foremost object of the present invention is to present a method and software to transform children's drawings into animated movies by using the specific software and addition of music and movements alongwith the storyline.

Another object of the present invention to present a novel method and software to solve a problem where, although demands for digitizing art works of children and storing them over a long period while preventing deterioration are prevailing, the children themselves are not satisfied with still images thereof, therefore the stored art works are hardly seen again.

Another object of the present invention to present a novel method and software to animate the child's drawing and optionally store it in a digital medium, such as a diskette, CD or DVD, whereby it can be viewed enjoyably in a home environment by using a computer, TV set or the like.

Another object of the present invention to present a novel method and software to animate the child's drawing and optionally store it electronically in the website.

Another object of the present invention to present a novel method and software to animate the child's drawing and optionally publish it on the Internet.

Yet another object of the present invention to present a novel method and software for entertaining the family including the child who is the author, and developing creativeness among the children.

A further object of the present invention to present a novel method and software that creates an educational toy and game which generates excitement and interest for children.

Additional objects, advantages and novel features of the invention will be set forth in part in the description which follows, and in part will become apparent to those skilled in the art upon examination of the following, or may be learned by practice of the invention, and further, when considered in reference to the following description and when taken in conjunction with the accompanying drawings listed below.

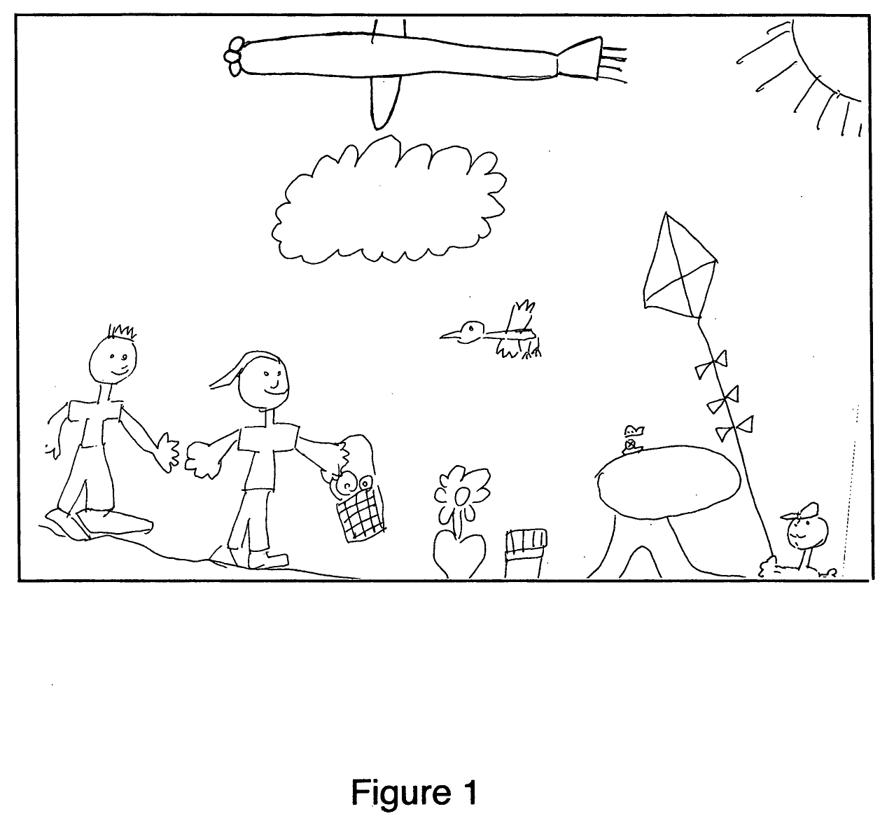

FIG. 1 is a child drawing capable of animation by present invention.

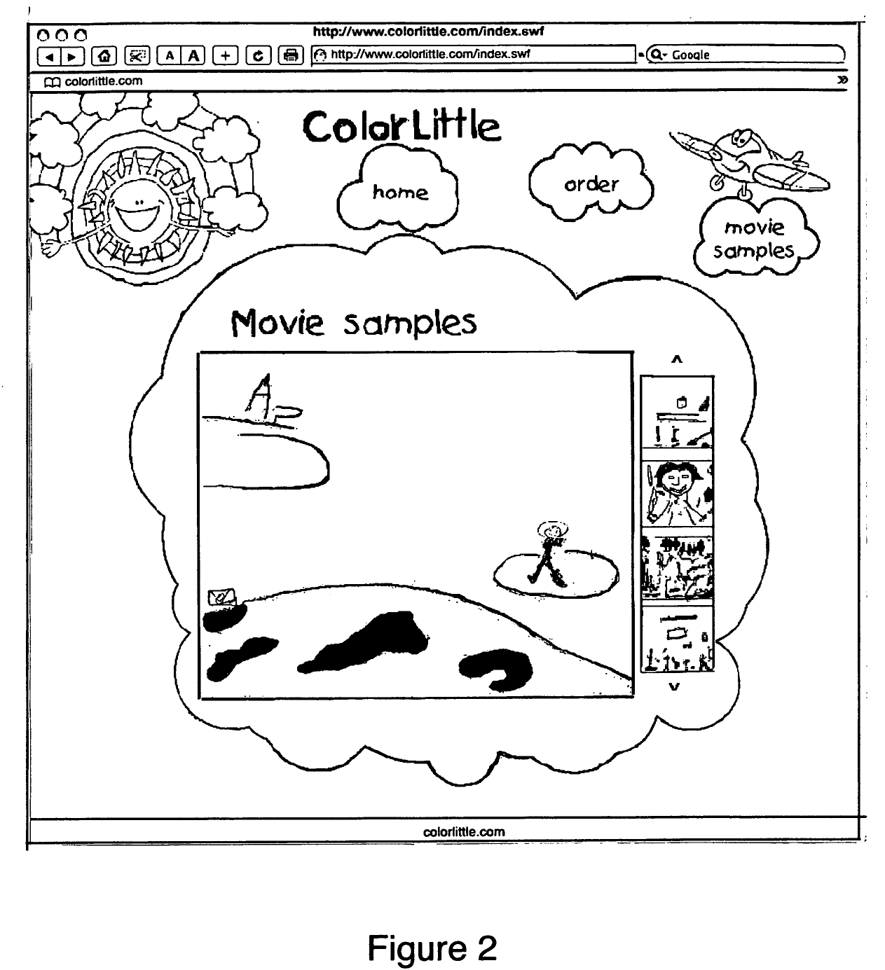

FIG. 2 is a screen grab image of website enabled by present invention, illustrating movie sample list.

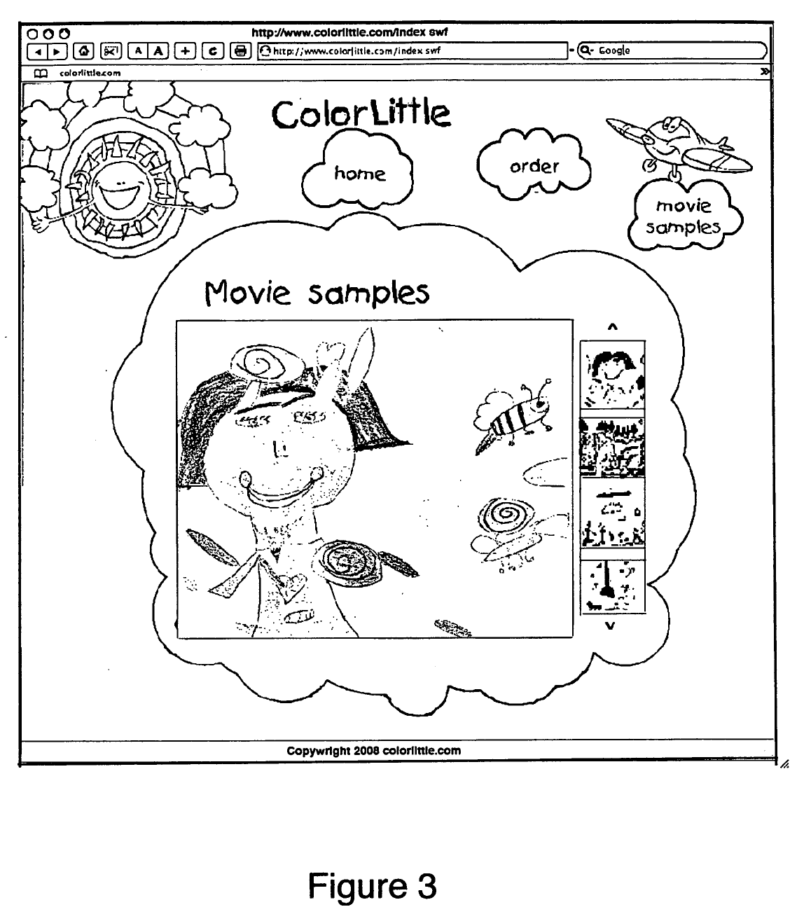

FIG. 3 is a screen grab image of website enabled by present invention, illustrating selection of movie from movie sample list.

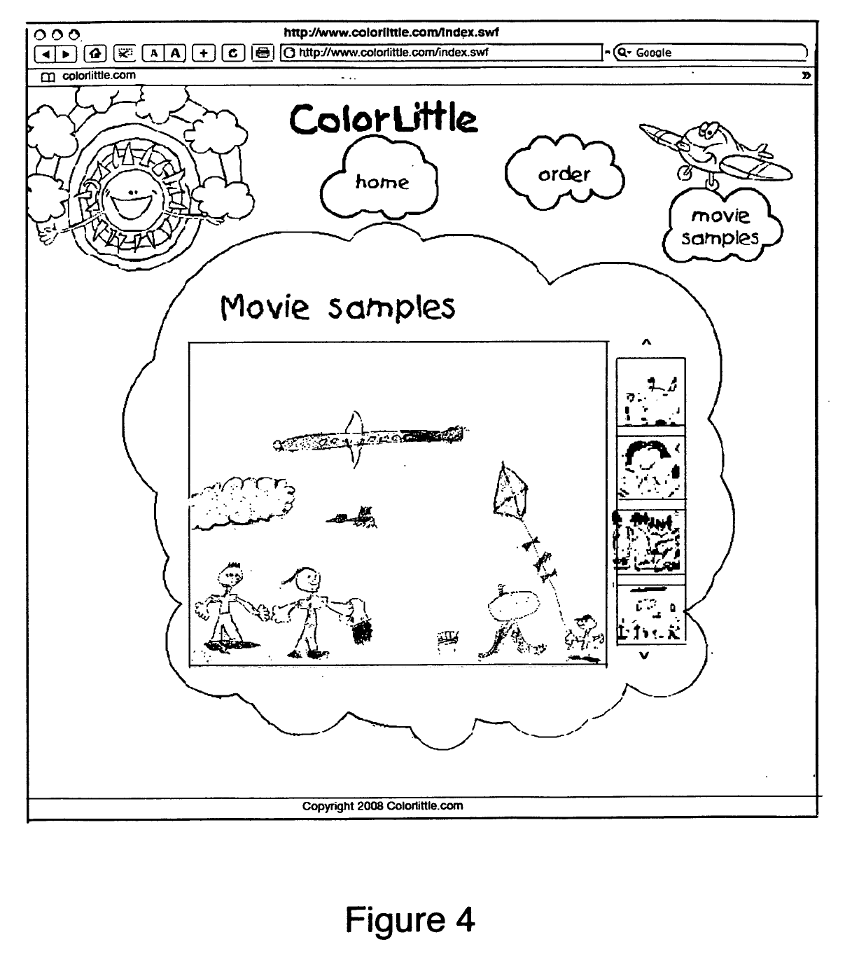

FIG. 4 is a screen grab image of website enabled by present invention, illustrating selection of movie from movie sample list.

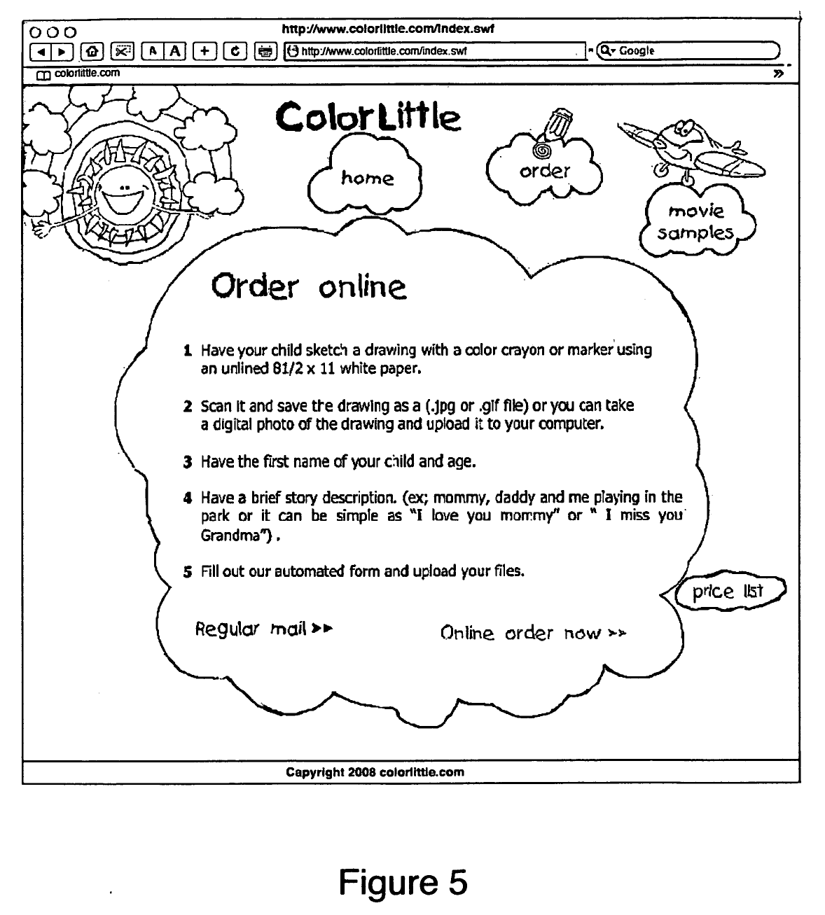

FIG. 5 is a screen grab image of website enabled by present invention, illustrating online order procedure.

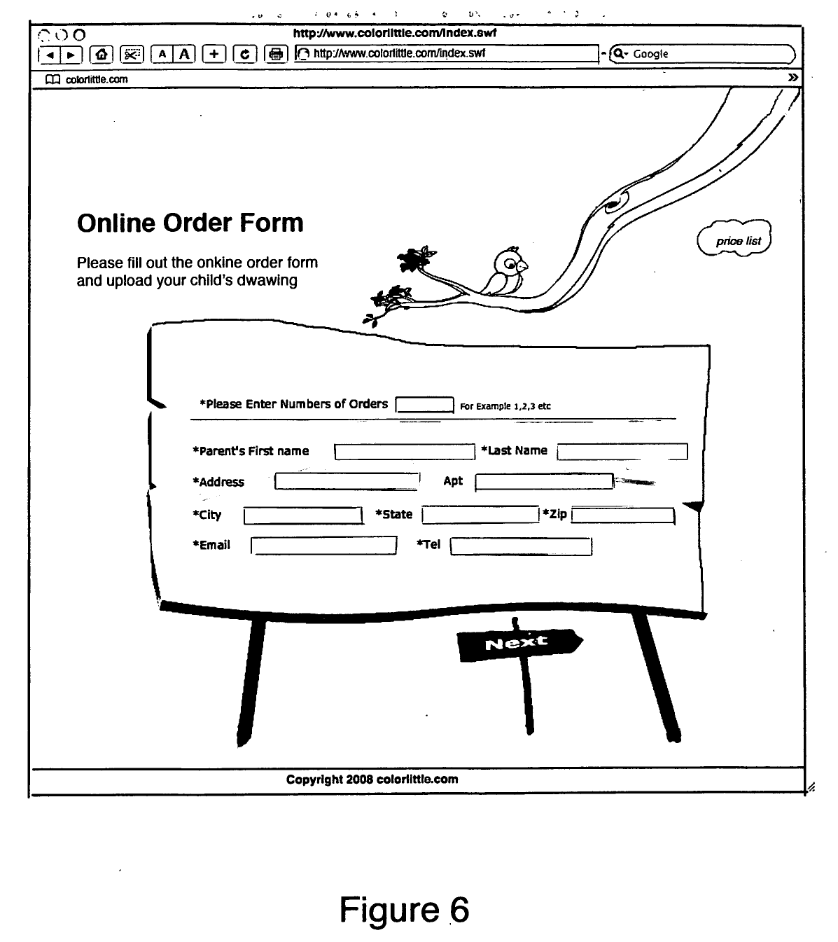

FIG. 6 is a screen grab image of website enabled by present invention, illustrating Online Order Form 1.

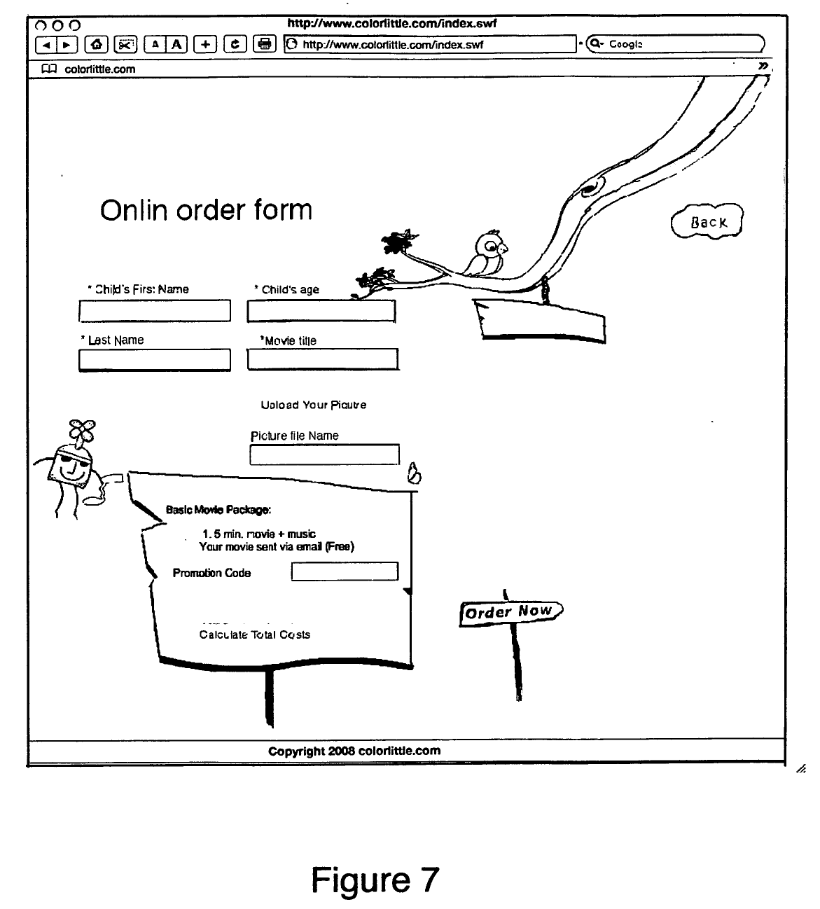

FIG. 7 is a screen grab image of website enabled by present invention, illustrating Online Order Form 2.

### DETAILED DESCRIPTION OF THE INVENTION

The following description is presented to enable any person skilled in the art to make and use the invention, and is provided in the context of particular applications of the invention and their requirements. The present invention can be configured as follows:

The computer system in accordance with the present invention will include computers, servers and other computers and processors, as well as storage devices and other related hardware, for performing the animation process. It will also consist of the Flash software and other softwares used to perform the animation services.

The drawings by the child may be created, on a physical medium, such as paper or the like, using a writing or drawing implement, such as crayons, pencils, pens, markers, etc. The child preferably sketches the drawing on an unlined 8½×11 white paper as illustrated in FIG. 1. The paper will contain a brief name or title (ex, “Mommy, Daddy And Me” “Celebrating My Birthday” or it can be simple as “I Love You Mommy”). Alternatively, the drawings by the child may be created in digital form using child drawing software along with a brief name or title. Drawings that exist on a physical medium can be scanned into one or more corresponding digital image files (such as jpeg, tiff or other format image files), using a digital scanner, thus creating a digital image of each drawing.

A storyline created by the child alone or in collaboration with his parents/siblings, will accompany the drawing. The storyline will describe how the characters and other elements are to interact or how they are to appear in the animation. The storyline may be created in physical form, for example, written on paper, or in digital form, using, for example, word processing software. The drawing and storyline can then be scanned and saved as a .jpg or .gif file. Alternatively a digital photo of the drawing can be taken and saved as a .jpg or .gif file.

The child's drawing and storyline and details such as the child's name, age, state and the name of the movie is then sent to the animation services system website via email or online form as shown in FIGS. 5, 6 and 7. Optionally the drawings and storyline and details such as the child's name, age, state and the name of the movie may be sent to the animation services system website mailing address on a physical, non-digital medium, such as paper, in which case the animation services system website can scan the drawings into digital files and may be stored electronically along with the drawings. Alternatively the drawings and storyline and details such as the child's name, age, state and the name of the movie, may be faxed to the animation services system website. Optionally audio information can be provided in non-digital form, such as on an analog tape, which can be converted into a digital audio file.

The digital images are opened by the animation services system using image processing software such as Flash. Each image is then parsed, using the image processing software, into a number of logical subunits that are to be animated. Those subunits may include the characters, or parts of characters, and other features identified in the storyline. For example, a single character may be parsed into a number of logical subunits, such as hands, arms, legs, feet, head, torso, etc. Each parsed subunit is then saved in its own file, in, e.g., jpeg format, or some other image format. A background image or scenery elements may also be provided in its own drawing, or otherwise identified, and saved in its own file. The animation services system thus makes the imported Flash drawing easily editable.

The animation services system assembles the image subunits on the screen in one or more layers. Each layer typically contains one or more subunits that comprise a character or object that may move independently of other characters or objects in the animation. The first layer is preferably a background image or scene.

The background can thus be removed and each character can be isolated as a standalone Object. The starting and ending positions and frames for various animation subunits can be specified.

As the image subunits are assembled, specific commands are given that convert the image subunits into animation subunits. Each character can be separately animated for moving, bending and making circles, moving up, down and sideways, zooming in and out, rotating, making circles and other movements and activities.

After the separate character and background animation, characters can be jointly animated for moving, bending and making circles, moving up, down and sideways, zooming in and out, rotating, making circles and other movements and activities.

After the separate and joint character and background animation, all layers are connected into a complete animated movie. The whole movie can be animated by using Flash technique for zoom in, zoom out and animating left and right. The movie can also be integrated with music and/or voice over recording, sound effects and other audible components.

The animated movie is then saved in a standard movie file format, such as in .swf flash file format viewable with Acrobat flash player, or any other such format. Since the file containing the animation may be quite large (e.g., over 1 GB), a compressed version of the animation file may be created for downloading on the animation services system website.

The animated movie will be sent to the client's email id with the link to view the animated movie. The client can also download the animated movie using the link. Optionally if the client has agreed to permit other people to see the animation over the Internet, the animated movie may also be posted on the animation services system website as shown in FIG. 2 and FIG. 3, so that other people interested in seeing the animation may view or download it.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A method of converting children's drawings into animated movies comprising of a child's drawing created on a physical or digital medium wherein said physical medium is an unlined 8½×11 white paper on which writing or drawing implement, such as crayons, pencils, pens, markers may be used and said digital medium is created using drawing software.

2. A method as claimed in claim 1 wherein said drawing contains a brief name or title, and is accompanied by a storyline and details such as the child's name, age, state and the name of the movie.

3. A method as claimed in claim 1 wherein said drawing can be scanned into one or more corresponding digital image files (such as jpeg, tiff or other format image files), using a digital scanner.

4. A method as claimed in claim 1 wherein a digital photo of said drawing can be be taken and saved as one or more corresponding digital image files (such as jpeg, tiff or other format image files).

5. A method as claimed in claim 1 wherein said drawing may be sent to the animation services system website mailing address on a physical, non-digital medium or faxed and scanned and stored electronically by said website.

6. A method as claimed in claim 1 wherein audio information can be provided in non-digital form and the same can be converted into a digital audio file by said website.

7. A method as claimed in claim 1 wherein said digital images are opened and animated using image processing software such as Flash.

8. A method as claimed in claim 1 wherein said digital images are parsed into a number of logical subunits that include the characters, or parts of characters, and other features identified in the storyline, using said software.

9. A method as claimed in claim 1 wherein said single character may be parsed into a number of logical subunits, such as hands, arms, legs, feet, head, torso, using said software.

10. A method as claimed in claim 1 wherein said parsed subunits are saved in individual jpeg format files.

11. A method as claimed in claim 1 wherein the starting and ending positions and frames for said subunits is specified.

12. A method as claimed in claim 1 wherein said parsed subunits are assembled on the screen in one or more layers containing one or more subunits that comprise a character or object capable of independent motion.

13. A method as claimed in claim 1 wherein the background image or scene is removed and each said character is isolated as a standalone object.

14. A method as claimed in claim 1 wherein said characters are separately animated for moving, bending and making circles, moving up, down and sideways, zooming in and out, rotating, making circles and other movements and activities.

15. A method as claimed in claim 1 wherein said characters are jointly animated for moving, bending and making circles, moving up, down and sideways, zooming in and out, rotating, making circles and other movements and activities.

16. A method as claimed in claim 1 wherein said layers are connected into a complete animated movie.

17. A method as claimed in claim 1 wherein said movie is animated for zoom in, zoom out and animating left and right.

18. A method as claimed in claim 1 wherein said movie is integrated with music and/or voice over recording, sound effects and other audible components.

19. A method as claimed in claim 1 wherein said movie is saved in a standard movie file format, such as in .swf flash file format.

20. A method as claimed in claim 1 wherein said animated movie from the child's drawing will be used to create promotions through art contest and the winner's art are converted to animated movies and posted on the internet through company websites, youtube, video sharing sites and blogs.
